(19) United States
(12) Patent Application Publication
(10) Pub. No.: US 2007/0014109 A1
(43) Pub. Date: Jan. 18, 2007

(54) Sign unit with colorful effect

(76) Inventor: Frank Pan, Rosemead, CA (US)

Correspondence Address: Raymond Y. Chan, 108 N. Ynez Ave., # 128, Monterey Park, CA, 91754, US

(21) Appl. No.: 11/182,425

(22) Filed: Jul. 15, 2005

(51) Int. Cl. F21V 9/00

(52) U.S. Cl. 362/231

(57) ABSTRACT

A sign unit includes at least a light module including a set of LEDs for generating primary color lights of red, green, and blue respectively, a module controller, which is adapted for electrically connecting to a power source, electrically coupling with the light module to selectively control each of the LEDs in an on and off manner to coordinate a combination of the primary color lights thereof so as to generate a colorful illumination effect from the light module, and a light diffusion housing receiving the light module therein to diffuse the primary color lights generated by the light module when the when the primary color lights penetrate through the light diffusion housing for softening the primary color lights so as to enhance an aesthetic appearance of the sign unit with the colorful illumination effect.

### BACKGROUND OF THE PRESENT INVENTION

1. Field of Invention

The present invention relates a lighting device, and more particularly to a sign unit which comprises at least a light module housed in a light diffusion housing to generate a colorful light effect, such as a candle light effect, when the colorful light produced by the light module is penetrating through the light diffusion housing.

2. Description of Related Arts

Lighting effect is one of the major factors for environmental decoration. For example, a spot light is adapted to create a high intensity of light to light up the room. Likewise, the user would like to lighten up the candles for creating a romance environment such as a candlelight dinner. However, such lighting devices have several drawbacks. The spot light not only produces the high intensity of the light to light up the room but also generates high intensity of heat which will heat up the room as well. The flame of the candle is too easy to be blown out and may cause accidental fire. In addition, both the spot light and the candle cannot produce any color lighting effect.

Fluorescent lamps or neon lights have long been utilized for a wide variety of lighting purposes, notably for advertisements and domestic use. People prefer fluorescent lamps to traditional light bulbs because they are generally long-lasting and brighter when compared with traditional light bulbs. Moreover, each of such fluorescent lamps or neon lights is capable of producing a color lighting effect which is more preferable for practical use. For example, when a particular trademark has to be lightened, fluorescent lamps and or neon lights are suitable for generating consistent line of light of different shapes.

Despite the advantages and popularity of the conventional fluorescent lamps and neon lights, they definitely have discrepancies. First of all, a practical disadvantage of them is that they are generally fragile. As a matter of fact, almost all of the fluorescent lamps have an outer light tube which is generally made of transparent materials, such as glass. As a result, although the outer light tube is good for light transmission, it is fragile and vulnerable to external forces.

Second, conventional neon lights and fluorescent lamps will generate a substantial amount of heat when operating and therefore inevitably produce a substantial amount of energy waste. Although one might argue that the fluorescent lamps, when compared with conventional light bulbs, have already saved a lot of energy and produced a reduced amount of heat when operating. Nonetheless, the fact that the fluorescent lamps produce less amount of heat as compared with conventional light bulbs does not mean that the relevant problem is effectively remedied.

In addition, conventional fluorescent lamps will develop a substantial potential difference between their respective terminals so as to create a great risk to their user. When electricity leak occurred, the consequence would be catastrophic.

Moreover, the substantial potential difference, from engineering point of view, is created by electrons movement between the two terminals. As a result, when the fluorescent lamps are operating, they tend to be unstable in that a light pattern generated by the fluorescent lamp may follow the path of the electrons movement, thus creating a changing light pattern. This is especially true when the fluorescent lamp is nearly put of its product life-time.

Due to the above discrepancies, there exists another type of illuminating device which is generally called the Light Emitting Diode (LED). Conventionally, each LED is capable of generating light in a very efficient manner. It consumes less energy than conventional neon lights and fluorescent lamps, usually non-fragile, and generates only very little amount of heat when operating. One reason for this is that for LED, most energy inputted will be converted into light (i.e. electromagnetic wave with visual wavelength). Thus, as most energy inputted is converted into light, less heat is generated. Thus, LED seems to be a perfect substitute for the conventional neon lights and fluorescent lamps.

### SUMMARY OF THE PRESENT INVENTION

A main object of the present invention is to provide a sign unit which comprises at least a light module housed in a light diffusion housing to generate a colorful light effect when the colorful light produced by the light module is penetrating through the light diffusion housing, so as to enhance the eye-catching impression of the sign unit.

Another object of the present invention is to provide a sign unit, wherein the light module comprises a set of LEDs producing a primary color light effect, including a red, green, and blue, such that by selectively controlling the LEDs, the light module is adapted to produce the colorful light effect, such as a candle light effect or even a disco lighting effect.

Another object of the present invention is to provide a sign unit, wherein the light diffusion housing can be made of light filtering lens to substantially diffuse the light from the light module so as to create a soft light effect to the environment.

Another object of the present invention is to provide a sign unit, wherein the light diffusion housing, having an irregular shape, has a 3-D peripheral surface arranged when the light penetrates through the light diffusion housing, the 3-D peripheral surface thereof creates a light-shading effect so as to enhance the aesthetic appearance of the sign unit.

Another object of the present invention is to provide a sign unit, which does not involve any expensive or complicated electrical or mechanical components so as to minimize the manufacturing cost and the ultimate selling price of the present invention.

Accordingly, in order to accomplish the above objects, the present invention provides a sign unit, comprising:

at least a light module comprising a set of LEDs for generating primary color lights of red, green, and blue respectively;

a module controller, which is adapted for electrically connecting to a power source, electrically coupling with the light module to selectively control each of the LEDs in an on and off manner to coordinate a combination of the primary color lights thereof so as to generate a colorful illumination effect from the light module; and

a light diffusion housing receiving the light module therein to diffuse the primary color lights generated by the light module when the when the primary color lights penetrate through the light diffusion housing for softening the primary color lights so as to enhance an aesthetic appearance of the sign unit with the colorful illumination effect.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a sign unit with a colorful effect according to a preferred embodiment of the present invention.

FIG. 2 is a sectional view of the sign unit according to the above preferred embodiment of the present invention.

FIG. 3 illustrates an alternative mode of a light module of the sign unit according to the above preferred embodiment of the present invention.

FIG. 4 illustrates an alternative mode of a light diffusion housing of the sign unit according to the above preferred embodiment of the present invention.

### DETAILED DESCRIPTION OF THE PREFERRED EMBODIMENT

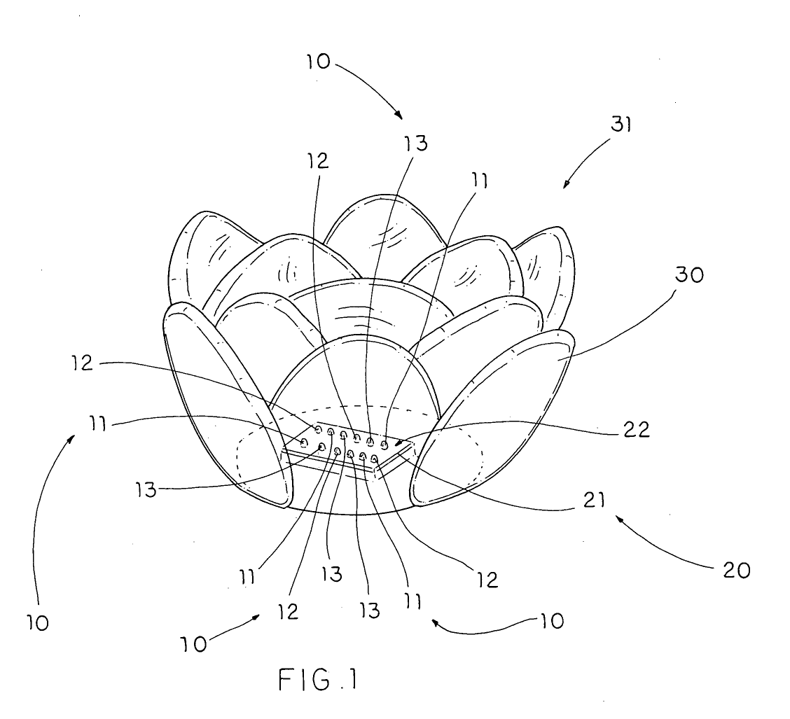

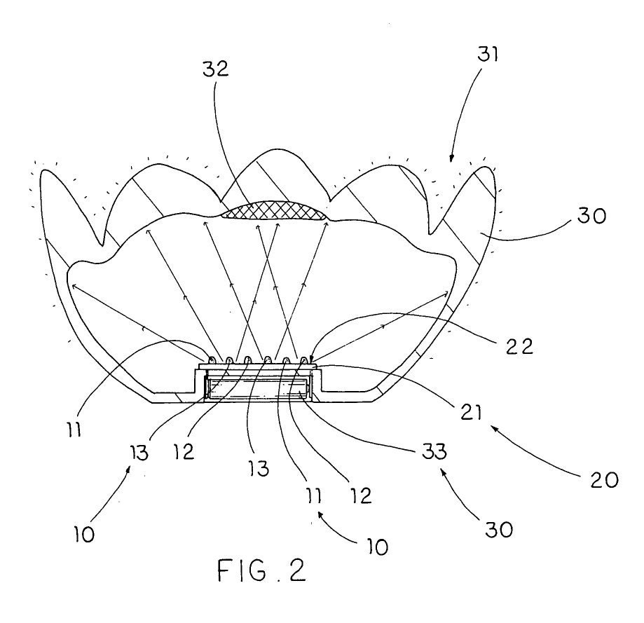

Referring to FIGS. 1 and 2 of the drawings, a sign unit according to a preferred embodiment of the present invention is illustrated, wherein the sign unit, such as a display sign or a decoration sign, comprises at least a light module 10 comprising a set of LEDs (Light Emitted Diode) 11, 12, 13 for generating primary color lights of red, green, and blue respectively, a module controller 20, and a light diffusion housing 30.

The module controller 20, which is adapted for electrically connecting to a power source, electrically coupling with the light module 10 to selectively control each of the LEDs 11, 12, 13 in an on and off manner to coordinate a combination of the primary color lights thereof so as to generate a colorful illumination effect from the light module 10.

The light diffusion housing 30 receives the light module 10 therein to diffuse the primary color lights generated by the light module 10 when the when the primary color lights penetrate through the light diffusion housing 30 for softening the primary color lights so as to enhance an aesthetic appearance of the sign unit with the colorful illumination effect.

According to the preferred embodiment, each of the LEDs 11, 12, 13 has a predetermined color of illumination for generating a particular primary color light. The LEDs 11, 12, 13 are positioned spacedly apart from each other at a predetermined distance such that when the LEDs 11, 12, 13 generate the primary color lights, the primary color lights can be effectively mixed with each other to create the colorful illumination effect. It is worth to mention that the LEDs 11, 12, 13 are capable of emitting light in an angle of approximately 120° (the projecting angle) in a radial direction. As a result, in order to optically blend in the primary color lights from the LEDs 11, 12, 13, the LEDs 11, 12, 13 should be positioned apart from each other to allow the mixture of the primary color lights to generate the colorful illumination effect.

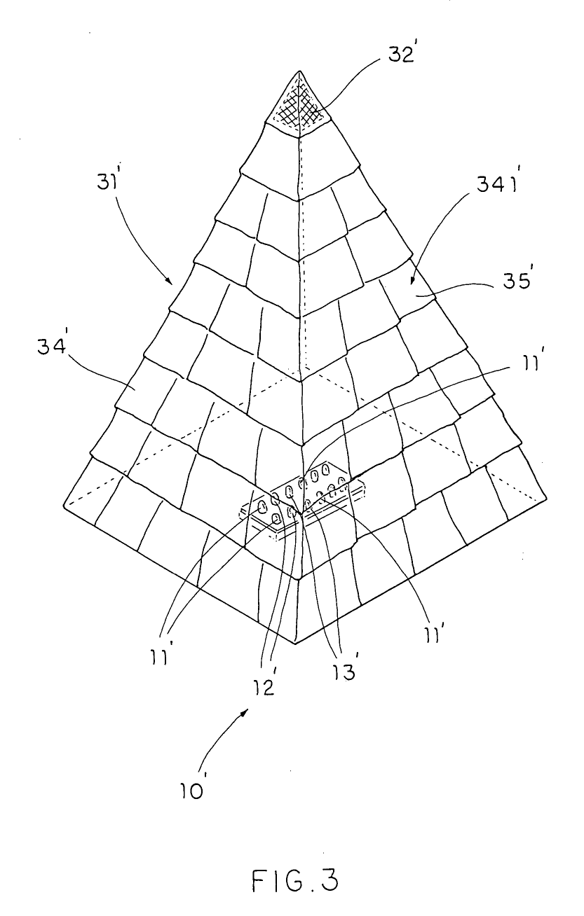

As shown in FIG. 1, the LEDs 11, 12, 13 are positioned in an irregular pattern to generate the primary color lights. In other words, the LEDs 11, 12, 13, which generate red, green and blue color lights, are randomly located with each other such that when the LEDs 11, 12, 13 are selectively activated by the module controller 20, different colorful illumination effects are generated correspondingly. Alternatively, the LEDs 11, 12, 13 are formed in a particular array, as shown in FIG. 3, that the LEDs 11′, 12′, 13′ which generate a particular color light are sorted in a LED set such that when the LED sets are selectively activated by the module controller, the sign unit of the present invention provides different colorful illumination effects correspondingly. For example, the LEDs 11′ which generate the red primary color lights are grouped together. Accordingly, more than two light modules 10′ are integral in one body structure that the LEDs 11′, 12′, 13′ are sorted in a particular array to create the color illumination effect via the module controller 20′, as shown in FIG. 3.

The module controller 20 comprises a circuit board 21 for the LEDs 11, 12, 13 electrically coupling thereon and a controlling circuit 22 provided on the circuit board 21 to electrically control with the LEDs 11, 12, 13. Accordingly, the module controller 20 can be programmed to selectively activate a lighting pattern of the light module 10. In other words, the module controller 20 is adapted to activate each of the LEDs 11, 12, 13 in an on and off manner such that the light module 10 generate a red color light when the corresponding LED 11, 12, 13 is activated only. It is worth to mention that when two or more light modules 10 are electrically connected with the module controller 20, the module controller 20 is adapted to selectively control the light modules 10 to generate the colorful illumination effect.

The light diffusion housing 30 is made of light filtering lens adapted to diffuse the primary color lights from the light module 10 when the primary color lights penetrate through the light filtering lens so as to soften the primary color lights. In addition, the light diffusion housing 30 can be made of translucent material such that when the LEDs 11, 12, 13 project the primary color lights towards light diffusion housing 30, the primary color lights are evenly diffused out of the light diffusion housing 30 to form the colorful illumination effect.

As shown in FIG. 1, the light diffusion housing 30, having an irregular shape, has a 3-D peripheral surface 31 arranged when the primary color light penetrates through the light diffusion housing 30, the 3-D peripheral surface 31 thereof creates a light-shading effect so as to enhance the aesthetic appearance of the sign unit of the present invention.

The light diffusion housing 30 further comprises a light blocker 32 formed at a position above the LEDs 11, 12, 13 of the light module 10 for blocking the primary color lights directly projecting towards the light diffusion housing 30. It is worth to mention that each of the LEDs 11, 12, 13 projects the primary color light as a point of light source. In order to prevent a bright spot formed on the light diffusion housing 30 when the LEDs 11, 12, 13 directly project the primary color lights the light diffusion housing 30, the light blocker 32 is positioned at the bright spot of the light diffusion housing 30. Accordingly, the light blocker 32 has a predetermined light transmisivity so as to block light passing therethrough.

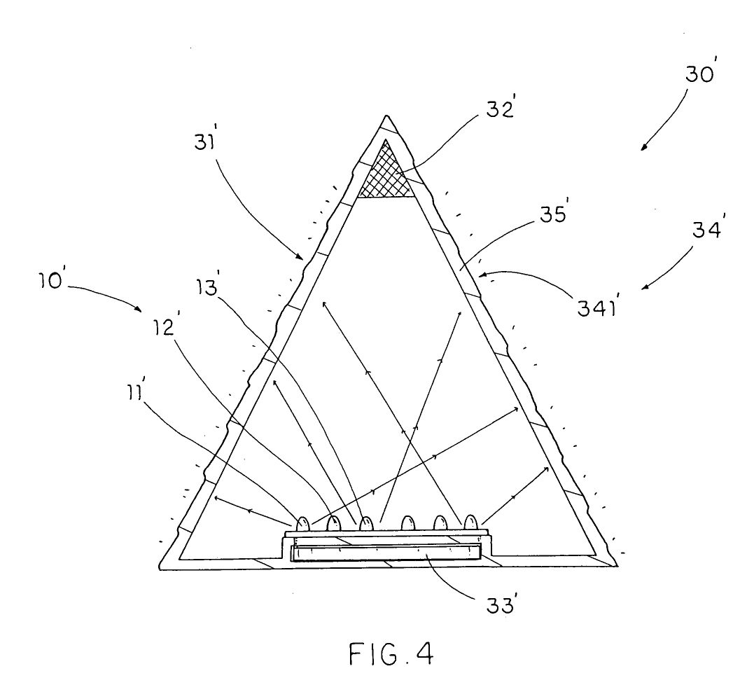

The light diffusion housing 30 further comprises a rechargeable battery 33 supported therein as the power source to electrically connect to the module controller 20 so as to enhance a portability of the sign unit. In other words, the sign unit of the present invention is formed as a portable unit adapted for the user to place at a desired location without wiring the sign unit to the external power supply. Alternatively, a battery compartment 33′ for receiving a replaceable battery therein as the power source is supported in the light diffusion housing 30′ to electrically connect to the module controller 20′, as shown in FIG. 4. It is worth to mention that the module controller 20′ is adapted to electrically connect to an external power supply as the power source for supplying electricity.

FIG. 4 illustrates an alternative mode of the light diffusion housing 30′ which comprises a housing body 34′ having a plurality of windows 341′ and a plurality of light filtering lenses 35′ mounted on the housing body 34′ at the windows 341′ respectively for diffusing the primary color lights through the windows 341′ so as to soften the primary color lights.

The module controller 20′ comprises a circuit board 21′ for the LEDs 11′, 12′, 13′ electrically coupling thereon and a controlling circuit 22′ provided on the circuit board 21′ to electrically control with the LEDs 11′, 12′, 13′.

The housing body 34′, having an irregular shape, has a 3-D peripheral surface 31′ arranged when the primary color light penetrates through the light diffusion housing 30′, the 3-D peripheral surface 31′ thereof creates a light-shading effect so as to enhance the aesthetic appearance of the sign unit of the present invention.

The light blocker 32′ is integrally formed on the housing body 34′ at a position above the LEDs 11′, 12′, 13′ of the light module 10′ for blocking the primary color lights directly projecting towards the light diffusion housing 30′ to form the bright spot thereon.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sign unit, comprising:
at least a light module comprising a set of LEDs for generating primary color lights of red, green, and blue respectively;
a module controller, which is adapted for electrically connecting to a power source, electrically coupling with said light module to selectively control each of said LEDs in an on and off manner to coordinate a combination of said primary color lights thereof so as to generate a colorful illumination effect from said light module; and
a light diffusion housing receiving said light module therein to diffuse said primary color lights generated by said light module when said when the primary color lights penetrate through said light diffusion housing for softening said primary color lights so as to enhance an aesthetic appearance of said sign unit with said colorful illumination effect.

2. The sign unit, as recited in claim 1, wherein said LEDs, which are positioned in an irregular pattern to generate said primary color lights, are positioned spacedly apart from each other at a predetermined distance such that when said LEDs generate said primary color lights, said primary color lights are effectively mixed with each other to create said colorful illumination effect.

3. The sign unit, as recited in claim 1, wherein said LEDs, which are formed in a particular array to sort said LEDs in a LED set which generates the same said primary color light, are positioned spacedly apart from each other at a predetermined distance such that when said LEDs generate said primary color lights, said primary color lights are effectively mixed with each other to create said colorful illumination effect.

4. The sign unit, as recited in claim 1, wherein said light diffusion housing is made of light filtering lens adapted to diffuse said primary color lights from said light module when said primary color lights penetrate through said light filtering lens so as to soften said primary color lights.

5. The sign unit, as recited in claim 2, wherein said light diffusion housing is made of light filtering lens adapted to diffuse said primary color lights from said light module when said primary color lights penetrate through said light filtering lens so as to soften said primary color lights.

6. The sign unit, as recited in claim 3, wherein said light diffusion housing is made of light filtering lens adapted to diffuse said primary color lights from said light module when said primary color lights penetrate through said light filtering lens so as to soften said primary color lights.

7. The sign unit, as recited in claim 4, wherein said light diffusion housing, having an irregular shape, has a 3-D peripheral surface arranged when said primary color light penetrates through said light diffusion housing, said 3-D peripheral surface thereof creates a light-shading effect so as to enhance said aesthetic appearance of said sign unit.

8. The sign unit, as recited in claim 5, wherein said light diffusion housing, having an irregular shape, has a 3-D peripheral surface arranged when said primary color light penetrates through said light diffusion housing, said 3-D peripheral surface thereof creates a light-shading effect so as to enhance said aesthetic appearance of said sign unit.

9. The sign unit, as recited in claim 6, wherein said light diffusion housing, having an irregular shape, has a 3-D peripheral surface arranged when said primary color light penetrates through said light diffusion housing, said 3-D peripheral surface thereof creates a light-shading effect so as to enhance said aesthetic appearance of said sign unit.

10. The sign unit, as recited in claim 1, wherein said light diffusion housing comprises a housing body having a plurality of windows and a plurality of light filtering lenses mounted on said housing body at said windows respectively for diffusing said primary color lights through said windows so as to soften said primary color lights.

11. The sign unit, as recited in claim 2, wherein said light diffusion housing comprises a housing body having a plurality of windows and a plurality of light filtering lenses mounted on said housing body at said windows respectively for diffusing said primary color lights through said windows so as to soften said primary color lights.

12. The sign unit, as recited in claim 3, wherein said light diffusion housing comprises a housing body having a plurality of windows and a plurality of light filtering lenses mounted on said housing body at said windows respectively for diffusing said primary color lights through said windows so as to soften said primary color lights.

13. The sign unit, as recited in claim 10, wherein said housing body, having an irregular shape, has a 3-D peripheral surface arranged when said primary color light penetrates through said light diffusion housing, said 3-D peripheral surface thereof creates a light-shading effect so as to enhance said aesthetic appearance of said sign unit.

14. The sign unit, as recited in claim 11, wherein said housing body, having an irregular shape, has a 3-D peripheral surface arranged when said primary color light penetrates through said light diffusion housing, said 3-D peripheral surface thereof creates a light-shading effect so as to enhance said aesthetic appearance of said sign unit.

15. The sign unit, as recited in claim 12, wherein said housing body, having an irregular shape, has a 3-D peripheral surface arranged when said primary color light penetrates through said light diffusion housing, said 3-D peripheral surface thereof creates a light-shading effect so as to enhance said aesthetic appearance of said sign unit.

16. The sign unit, as recited in claim 8, wherein said light diffusion housing further comprises a light blocker formed at a position above said LEDs of said light module for blocking said primary color lights directly projecting towards said light diffusion housing so as to prevent a bright spot thereon.

17. The sign unit, as recited in claim 9, wherein said light diffusion housing further comprises a light blocker formed at a position above said LEDs of said light module for blocking said primary color lights directly projecting towards said light diffusion housing so as to prevent a bright spot thereon.

18. The sign unit, as recited in claim 14, wherein said light diffusion housing further comprises a light blocker formed at a position above said LEDs of said light module for blocking said primary color lights directly projecting towards said light diffusion housing so as to prevent a bright spot thereon.

19. The sign unit, as recited in claim 15, wherein said light diffusion housing further comprises a light blocker formed at a position above said LEDs of said light module for blocking said primary color lights directly projecting towards said light diffusion housing so as to prevent a bright spot thereon.

20. The sign unit, as recited in claim 16, wherein said light diffusion housing further comprises a rechargeable battery supported therein as said power source to electrically connect to said module controller so as to enhance a portability of said sign unit.

21. The sign unit, as recited in claim 17, wherein said light diffusion housing further comprises a rechargeable battery supported therein as said power source to electrically connect to said module controller so as to enhance a portability of said sign unit.

22. The sign unit, as recited in claim 18, wherein said light diffusion housing further comprises a rechargeable battery supported therein as said power source to electrically connect to said module controller so as to enhance a portability of said sign unit.

23. The sign unit, as recited in claim 19, wherein said light diffusion housing further comprises a rechargeable battery supported therein as said power source to electrically connect to said module controller so as to enhance a portability of said sign unit.
